(19) United States
(12) Patent Application Publication
(10) Pub. No.: US 2025/0146154 A1
(43) Pub. Date: May 8, 2025

(54) PROCESS TO PRODUCE HYDROGEN AND OXYGEN FROM UNDERGROUND SYSTEMS

(71) Applicant: DEEPH2 INC., Calgary (CA)

(72) Inventors: Ian Gates, Calgary (CA); Hugh Macrae, Calgary (CA); Jingyi Wang, Calgary (CA)

(21) Appl. No.: 18/834,175

(22) PCT Filed: Jan. 27, 2023
(86) PCT No.: PCT/CA2023/050119

§ 371 Date: Jul. 29, 2024

Related U.S. Application Data
(60) Provisional application No. 63/303,885, filed on Jan. 27, 2022.

(51) Int. Cl. C25B 15/08; C25B 1/04; C25B 9/19; C25B 9/65; C25B 9/70; E21B 43/38; F01D 15/10; H01M 8/0656

(52) U.S. Cl. CPC C25B 15/083; C25B 1/04; C25B 9/19; C25B 9/65; C25B 9/70; E21B 43/38; F01D 15/10; H01M 8/0656

(57) ABSTRACT

A system and method for producing hydrogen wherein the system comprises at least one electrolyzer adapted to be located within a subterranean formation, at least one electrical supply cable having a length selected to extend from the at least one electrolyzer to a ground surface power supply, at least one supply tubing string having a length selected to extend from the at least one electrolyzer to a water supply at the ground surface and at least one collection tubing string having a length selected to extend from the at least one electrolyzer to a collection location at the ground surface. The method comprises providing a well from a surface to an underground formation, locating at least one electrolyzer in the well, supplying the at least one electrolyzer with supply electricity, supplying the at least one electrolyzer with supply water, producing hydrogen gas at the electrolyzer and collecting and transporting the produced hydrogen gas to the surface.

### BACKGROUND

### 1. Technical Field

This disclosure relates generally to underground production of hydrogen and oxygen electrolysis using in-situ geothermal heat.

### 2. Description of Related Art

Given climate change, there is a need to shift global energy systems to clean zero greenhouse gas (GHG) emission energy systems. At present, the majority of raw energy supply used by humanity is derived from hydrocarbon-based fuels such as gasoline, diesel, kerosene, crude oil, heavy oil, bitumen, coal, and peat. One key challenge confronted by the use of hydrocarbon-based fuels is that on consumption (where the fuels are combusted), they generate carbon dioxide, a potent greenhouse gas.

There is an ongoing desire to produce fuels such as hydrogen that are more carbon dioxide neutral. Moreover, hydrogen is a useful chemical feedstock for production of commodity chemicals and materials e.g. ammonia, methanol, and steel.

There are several methods that are used commercially to produce hydrogen. The most used commercial method to produce hydrogen is steam-methane reforming where steam is reacted with steam to produce a mixture of carbon monoxide, carbon dioxide, hydrogen, and water (vapour). This mixture is referred to as synthesis gas. The hydrogen is separated from the synthesis gas. In some cases, steam reforming of heavier hydrocarbons is conducted for the production of hydrogen. One challenge faced by steam-reforming methods is that it generates carbon dioxide which is typically emitted to the atmosphere. The carbon dioxide can be sequestered or converted into products but this incurs further energy and consequent emissions as well as costs.

Another commercial method to produce is via electrolysis where an electrical current is used to break water into its constituent elements, namely oxygen and hydrogen. This method requires electricity which can be generated from fossil fuel (e.g. oil, gas, coal) or renewable (e.g. solar, wind, geothermal) or nuclear sources. If renewables or nuclear are used, during its operation, the emissions of GHGs are reduced to nearly zero or zero production. However, current electrolysis methods are expensive and produce hydrogen at low pressure which requires additional energy and consequent emissions for raising its pressure.

U.S. Pat. No. 7,326,329 describes a method to produce hydrogen via electrolysis using a diaphragm-less electrolytic cell consisting of separate anode and cathode cells that is supplied by a DC power source.

U.S. Pat. No. 7,191,737 describes a method to produce hydrogen via electrolysis where the generated hydrogen is stored in a gas reservoir which is then directly provided to an internal combustion engine.

European Patent 1,716,602 describes a method to produce hydrogen via electrolysis using sunlight where a photovoltaic power cells is connected to the electrolyzer for generation of hydrogen.

U.S. Pat. No. 10,487,408 describes a method to produce hydrogen via electrolysis where the system consists of a first compartment with an electrode for reducing water to hydrogen and another separate second compartment with an electrode for generating oxygen with its electrode connected electrically to the electrode of the first compartment.

International Patent Application Publication No 2006/113463 describes an apparatus and method for production of hydrogen which uses a catalytic electrolysis cell.

International Patent Application Publication No 2021/099986 provides a device and method for electrolysing water using an alkaline medium for hydrogen production. This method consists of first and second charge batteries such that the first battery operates in a discharging mode where hydrogen gas is produced and the second battery operations in a charging process generating oxygen gas. The operation of the system consists of repeated cycles between the two batteries to alternatively produce hydrogen and oxygen between the two batteries.

U.S. Pat. No. 8,282,811 describes a multi-cell hydrogen production and compression device. The device is fed with water, thereby electrochemically splitting into oxygen gas and hydrogen protons. The hydrogen protons are attracted to the first anode to form hydrogen gas. Then, the moist hydrogen is fed to the anode of the second cell to which it is split again into protons. The protons are attracted to the cathode of the second cell. Due to the ability of differential pressure operation across the proton exchange membrane, this device claims to produce high pressure hydrogen at a higher efficiency than a single differential pressure cell or a single same pressure difference cell.

None of the prior methods mentioned above produce hydrogen and oxygen that under pressurization; all of the hydrogen and oxygen is produced at atmospheric pressure. All of the prior methods would require subsequent design constraints to yield pressurized hydrogen in an atmospheric environment. In typical practice, for transport of hydrogen in conventional tube trailers, it must be compressed to over 350 atmospheres.

### SUMMARY OF THE DISCLOSURE

According to a first embodiment, there is disclosed a system for producing hydrogen comprising at least one electrolyzer adapted to be located within a subterranean formation, at least one electrical supply cable having a length selected to extend from the at least one electrolyzer to a ground surface power supply, at least one supply tubing string having a length selected to extend from the at least one electrolyzer to a water supply at the ground surface and at least one collection tubing string having a length selected to extend from the at least one electrolyzer to a collection location at the ground surface

The electrolyzer may include at least one cathode formed of material selected from the group consisting of ruthenium, rhodium, palladium, silver, osmium, iridium, platinum and gold on a substrate formed of a material selected from the group consisting of carbon, titanium dioxide, graphene and alumina. The electrolyzer may include at least one anode formed of a material selected from the group consisting of iridium oxide and ruthenium oxide blacks and perfluoroalkylsulfonic acid. The electrolyzer may include at least one proton exchange membrane to enable separated generation points of oxygen and hydrogen in the electrolyzer.

The electrolyzer, water, hydrogen and oxygen tubing strings may be surrounded by water. The at least one electrolyzer may comprise at least one the electrolytic cell separated into a first compartment with an electrode for reducing water to hydrogen and second compartment separate from the first compartment with an electrode for generating oxygen.

A plurality of electrolytic cells may be connected together in series or in parallel within the well. The system may further comprise a pressure regulator adapted to control the pressure of at least one of produced hydrogen or oxygen within one of the hydrogen tubing string or the oxygen.

According to a first embodiment, there is disclosed a method for producing hydrogen comprising providing a well from a surface to an underground formation, locating at least one electrolyzer in the well, supplying the at least one electrolyzer with supply electricity, supplying the at least one electrolyzer with supply water, producing hydrogen gas at the electrolyzer and collecting and transporting the produced hydrogen gas to the surface.

The supply electricity may be transported to the at least one electrolyzer from the surface through an electrical power supply cable extending therebetween. The supply water may be transported from the surface to the at least one electrolyzer through a supply tubing string extending therebetween. The supply water may be introduced into the supply tubing string at an elevated pressure. The supply water may be introduced into the supply tubing string at an elevated temperature.

The method may further comprise transporting the produce hydrogen within at least one collection tubing string extending from the at least one electrolyzer to the surface. The method may further comprise controlling the surface production of hydrogen or oxygen or both from their respective tubing strings to maintain a desired pressure of the gases in their respective tubing strings. The method may further comprise and utilizing the underground well as structural support for produced hydrogen storage before transportation to the surface. A pressure of the generated hydrogen and oxygen gases in their respective tubing strings may be accumulated until a desired pressure is reached up to and not exceeding the maximum underground storage pressure of the tubing strings.

The method may further comprise determining the highest temperature location within the well and locating the at least one electrolyzer at the highest temperature location. The method may further comprise locating the at least one electrolyzer at the deepest section of the well. The well may be selected to be a post-steam or post-thermal recovery process oil reservoir.

The produced hydrogen may be passed through a fuel cell to generate power. The produced water may be injected into the well to supply the electrolyzer. The produced hydrogen may be combusted to generate at least one of power, heat and steam. The produced water or condensed steam may be injected into the well to supply the electrolyzer. The electrical power used by the electrolyzer may be supplied from at least one of a solar photovoltaic cell, wind, hydro, nuclear and fuel generator. At least one of the produced oxygen and hydrogen may be passed through a turbine-generator to create at least one of rotational energy and electrical power. The hydrogen may be reduced from water in a first compartment with an electrode for reducing water to hydrogen oxygen is reduced from water in a second compartment which is located separate from the first compartment with an electrode connected electrically to the electrode of the first compartment.

The water in the electrolyzer may be at the hydrostatic pressure at the submersion depth of the electrolyzer. The generated oxygen and hydrogen may be at the pressure of the electrolyzer and is delivered into their respective production tubing strings that are connected to the electrolyzer and surface.

According to a first embodiment, there is disclosed a method for producing hydrogen from a underground system comprising providing a well from surface to the underground, locating at least one electrolyzer in the well at one or more depths, supplying water to the electrolyzer through a connection, supplying electrical current to the electrolyzer to generate oxygen and hydrogen, separating the generated oxygen and hydrogen to fill at least one hydrogen tubing string and at least one oxygen tubing string to a desired pressure and producing the gases from the tubing strings separately at the desired target pressure on surface. The method further comprises generating energy through at least one of passing at least one of the high pressure oxygen and hydrogen through a turbine to generate rotational energy, passing at least one of the high pressure oxygen or hydrogen a turbine and electrical generator to generate electrical power, feeding the produced hydrogen to a combustion engine and combusting it for rotational energy, feeding the hydrogen to combustor for heat and feeding the hydrogen to a fuel cell for the generation of electrical power. The method further comprises providing the produced water from the step of generating energy to feed the electrolyzer, passing the high pressure oxygen at a desired pressure to a storage vessel on the surface for storage or transport and passing the high pressure hydrogen at a desired pressure to a storage vessel on the surface for storage or transport.

According to a further embodiment, there is disclosed a method for producing hydrogen from a underground system, the method comprising:
a. providing a well from surface to the underground;
b. locating at least one electrolyzer in the well at one or more depths;
c. supplying water to the electrolyzer through a connection;
d. supplying electrical current to the electrolyzer to generate oxygen and hydrogen from any source of power including solar, wind, hydro, geothermal, nuclear, fossil fuel (natural gas, hydrocarbon fuels, or coal), and other oxidizable fuels (e.g. nitrogen-based fuels);
e. separating the generated oxygen and hydrogen to fill two separate tubing strings (pipes), each string connected to the electrolyzer, with each gas filling their respective tubing string to a desired pressure;
f. producing the gases from the tubing strings separately at the desired target pressure on surface;
g. passing the high pressure oxygen or hydrogen or both through a turbine to generate rotational energy;
h. passing the high pressure oxygen or hydrogen or both through a turbine and electrical generator to generate electrical power;
i. feeding the hydrogen after steps a-h to a combustion engine and combusting it for rotational energy;
j. feeding the hydrogen after steps a-h to combustor for heat;
k. feeding the hydrogen after steps a-h to a fuel cell for the generation of electrical power;
l. taking the produced water from steps i-k and using it to feed the electrolyzer (Step c);
m. passing the high pressure oxygen at a desired pressure to a storage vessel on the surface for storage or transport; and
n. passing the high pressure hydrogen at a desired pressure to a storage vessel on the surface for storage or transport.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is an illustration of a system for generating hydrogen within a subterranean well according to a first embodiment of the present disclosure.

FIG. 2 is a cross sectional view of the electrolyzer of the system of FIG. 1 located within a cased vertical well where electrical current and water is fed to the electrolyzer and hydrogen and oxygen gases are produced and stored in their respective tubing strings.

FIG. 3 is a cross sectional view of the electrolyzer of the system of FIG. 1 located within an open hole vertical well where electrical current and water is fed to the electrolyzer and hydrogen and oxygen gases are produced and stored in their respective vertical tubing strings.

FIG. 4a is a cross sectional view of the electrolyzer of the system of FIG. 1 within a vertical well according to a further embodiment of the present disclosure where electrical current and water is fed to a series of electrolyzers and hydrogen and oxygen gases are produced and stored in their respective vertical tubing strings.

FIG. 4b is are cross-sectional views of the well and tubing strings of FIG. 4a above and at the electrolyzer.

FIG. 5a is a cross sectional view of the electrolyzer of the system of FIG. 1 within a vertical well according to a further embodiment of the present disclosure where electrical current and water is fed to a series of double-chamber electrolyzers and hydrogen and oxygen gases are produced and stored in their respective vertical tubing strings.

FIG. 5b is are cross-sectional views of the well and tubing strings of FIG. 5a above and at the electrolyzer.

FIG. 6a is a cross sectional view of the electrolyzer of the system of FIG. 1 within a vertical well according to a further embodiment of the present disclosure where electrical current and water is fed to a series of electrolyzers and hydrogen and oxygen gases are produced and stored in their respective vertical tubing strings in a concentric arrangement.

FIG. 6b is are cross-sectional views of the well and tubing strings of FIG. 6a above and at the electrolyzer.

FIG. 7a is a cross sectional view of the electrolyzer of the system of FIG. 1 within a vertical well according to a further embodiment of the present disclosure where electrical current and water is fed to a series of triple-chamber electrolyzers and hydrogen and oxygen gases are produced and stored in their respective vertical tubing strings.

FIG. 7b is are cross-sectional views of the well and tubing strings of FIG. 7a above and at the double-chamber electrolyzer.

FIG. 8 is a cross sectional view of the electrolyzer of the system of FIG. 1 within a cased horizontal well according to a further embodiment of the present disclosure where electrical current and water is fed to the electrolyzer; thereby, hydrogen and oxygen gases are produced and stored in their respective horizontal tubing strings.

FIG. 9 is a cross sectional view of the electrolyzer of the system of FIG. 1 within an open hole horizontal well according to a further embodiment of the present disclosure where electrical current and water is fed to the electrolyzer; thereby, hydrogen and oxygen gases are produced and stored in their respective horizontal tubing strings

FIG. 10 is an illustration of the electrolyzer of the system of FIG. 1 which enables the generation of oxygen and hydrogen from water

FIG. 11 is a side view of the electrolyzer of the system of FIG. 1 located within a well according to a further embodiment of the present disclosure.

### DETAILED DESCRIPTION

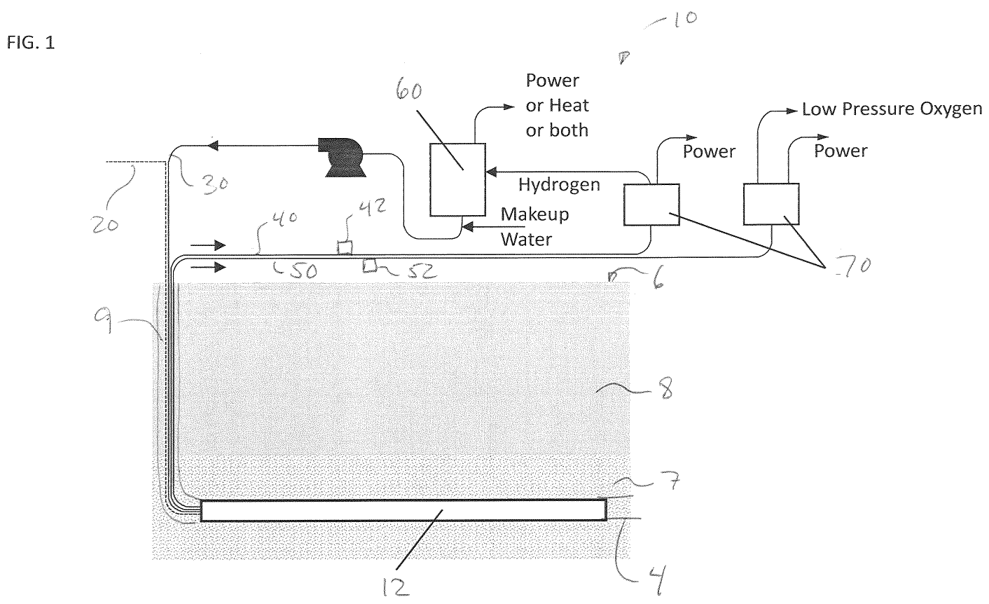

Aspects of the present disclosure are now described with reference to exemplary apparatuses, methods and systems. Referring to FIG. 1, an exemplary system producing hydrogen according to a first embodiment is shown generally.

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

In broad aspects, the exemplary methods and systems described herein use an electrolyzer placed underground to generate hydrogen and oxygen gases from water. Performing electrolysis underground takes advantage of the geothermal (heated) conditions for better thermodynamics, underground structural support of the well for high pressure storage and operating downhole under pressure for better separation and gas removal.

In general, the present specification describes systems and methods to convert water to generate hydrogen and oxygen. The methods include injection of water and electrical power into the well to supply one or more electrolyzers placed within the well to convert the water to hydrogen and oxygen gases which are then supplied to their respective tubing strings and stored there at a desired pressure. The gases are then withdrawn from the tubing strings at a desired pressure at the surface that is equal or less than the electrolyzer system pressure. Either one or both produced gases may be vented to the atmosphere or collected for use in subsequent processes. The produced hydrogen may be consumed at the surface to generate power or heat or both or consumed as a chemical feedstock for production of other materials.

FIG. 1 illustrates one embodiment of the system taught generally at 10. One or more electrolyzers 12 are placed within a well 9 at specified locations in the well within a soil formation 8, such as by way of non-limiting example within a target zone 7. To achieve the greatest pressure of produced gases, the preferred case is when the electrolyzers are placed at the base of the well if the well is vertical or along the horizontal section 4 of a horizontal well. To achieve the greatest efficiency of electrolysis, the electrolyzer is placed at the hottest location along the well. The highest temperature locations along the well can be obtained from a temperature survey along the well. Electrolyzers 12 placed within the well 9 are connected to the surface 6 through four line—a electrical power line 20 as well as three tubing strings. In particular, a water tubing string 30 provides water to the electrolyzer; a hydrogen tubing string 40 is used for the collection of hydrogen from the electrolyzer 12 and an oxygen tubing string 50 for the collection of oxygen from the electrolyzer 12, respectively, generated from the electrolysis of the water supplied to the electrolyzer. The water may be pumped to the electrolyzers from the surface as set out here or may optionally obtained from the surrounding soil and rock formations. It will be appreciated that such water will preferably be relatively pure with a low salinity level to ensure longevity of the electrolyzer. The hydrostatic pressure arising from the height of water in the tubing string, sets the minimum pressure of the operation of the electrolyzer and the hydrogen and oxygen gases generated in the electrolyzer. The tubing strings for each of the produced gases are regulated at the surface so that the pressure of the gases in each of the tubing strings accumulates as they are generated. When the desired pressure of each of the gases is reached in each of their respective tubing strings, the gases can be produced at surface at a desired pressure which can be controlled through the use of regulators 42 and 52 or equivalent devices. In the space between the tubing strings, the external space can be filled with water so as to provide a mass transfer resistance to the loss of hydrogen from the hydrogen tubing string.

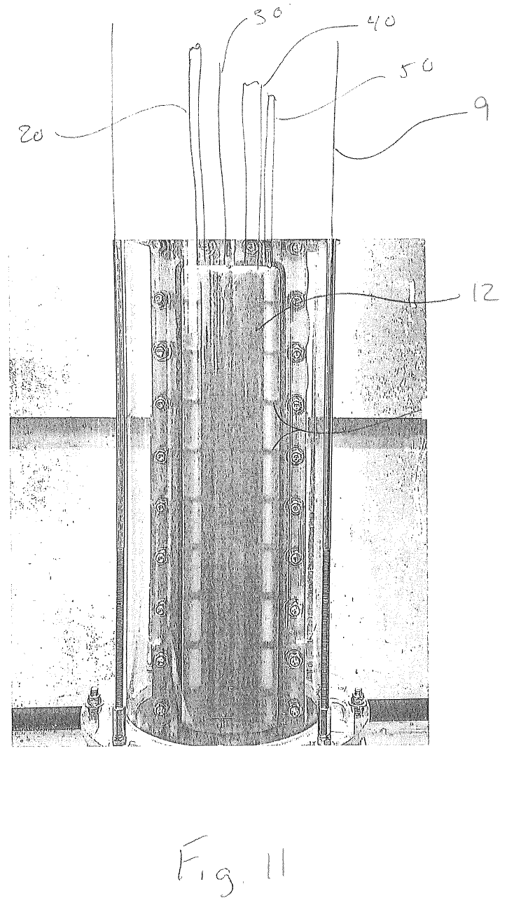

Turning now to FIG. 11, an exemplary electrolyzer 10 is located within a well 8. The electrolyzer 10 may include or more surface treatments to assist with heat transfer to the electrolyzer 10, including by way of non-limiting example fins 12 or the like. The electrolyzer 10 includes a water string 20 and power line 30 extending to the electrolyzer from the surface and a hydrogen and string, 40 and 50, respectively extending away from the electrolyzer to the surface. As is commonly known an electrolyzer enables the generation of oxygen and hydrogen from water.

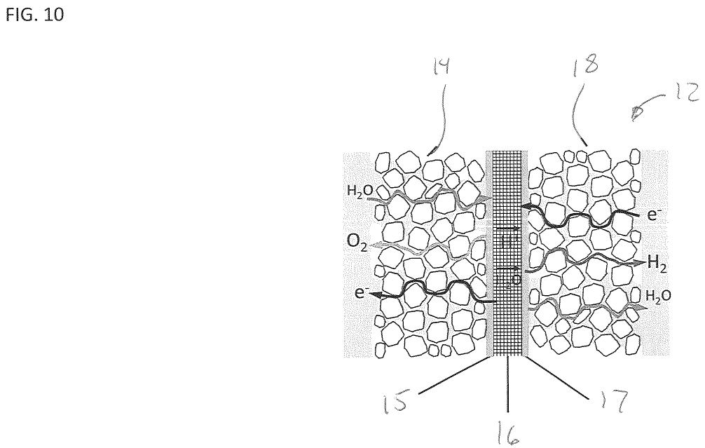

In particular, as illustrated in FIG. 10 showing a simplified configuration the electrolyzer 12 including an anode porous support 14, anode catalyst 15, proton exchange membrane 16, cathode catalyst 17 and cathode porous support 18. The membrane 16 separates the electrolytic cell into a first compartment with a cathode or first electrode for reducing water to hydrogen and another separate second compartment which can be located separate from the first compartment with an anode or second electrode for generating oxygen with its electrode connected electrically to the electrode of the first compartment. Multiple electrolytic cells may be connected together in series or in parallel within the well as will be set out further below and illustrated in the figures. The electrolyzer may use a proton exchange membrane to enable separated generation points of oxygen and hydrogen in the electrolyzer. A proton exchange membrane permits the transport of hydrogen ions, facilitating the formation of hydrogen gas in a separated compartment to the oxygen gas formation. The electrolyzer may use one or more or combinations of the following materials for electrodes: noble metal materials such as ruthenium, rhodium, palladium, silver, osmium, iridium, platinum and/or gold are deposited onto carbon, titanium dioxide, graphene and/or alumina support as the cathode catalyst for high activity and stability; iridium oxide and/or ruthenium oxide blacks as the anode catalyst for high activity and stability; perfluoroalkylsulfonic acid known by the trade names such as Nafion, Flemion or Aquivion which offer a compromise of area-specific resistance, low gas crossover and mechanical robustness; and finally porous steel, titanium and/or aluminum or other metal separators to maintain mechanical support for the cell.

At start-up of operations, the external space and water tubing string may be completely filled with water. The oxygen and hydrogen tubing strings may also initially be filled with water.

Thereafter, electrical power is supplied to the electrolyzer and as the gases are generated, the water is displaced from the gas tubing strings. As the system continues to consume water and generate more hydrogen and oxygen, water is fed into the water tubing string and gases are withdrawn at surface at the desired pressure. Optionally, the hydrogen may be collected within the annulus around the electrolyzer and/or supply tubes to and from the electrolyzer for transportation to the surface. The electrolyzer may use a control system to prevent water ingress into the oxygen and hydrogen tubing strings.

In typical continental crust, over the first few kilometers, the temperature gradient is of order of about 25 deg. C./km depth. This means for a 3 km deep well, as would be typically found for a tight rock natural gas reservoir, the temperature would be of order of 75 deg. C. The positioning of the electrolyzer at this depth enables it to operate under geothermal heating which consequently raises its electrical efficiency. This is one benefit of the method and device is natural geothermal heat. Optionally, the water supplied to the electrolyzer may be heated at the surface to a desired temperature for injection into the well.

For a target zone at 3 km deep, the hydrostatic pressure at that depth would be the sum of the atmospheric pressure and the liquid column head, that is 101325 Pa+(1000 kg/m3)(9.81 m/s2)(3000 m)=29,531 kPa=291.5 atmospheres. This means that the oxygen and hydrogen gas is generated at 291.5 atmospheres where the electrolyzer is placed at this depth. Thus, as each of the gases accumulates in their respective tubing strings, they accumulate reaching the generation pressure when the tubing strings are closed at the surface. The gases can then be produced at surface at pressure up to the generation pressure.

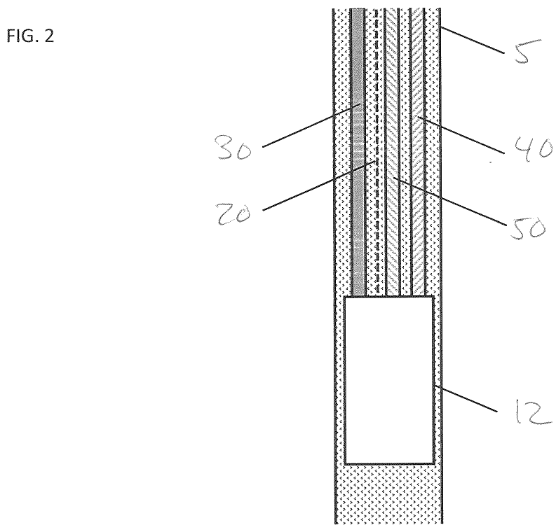

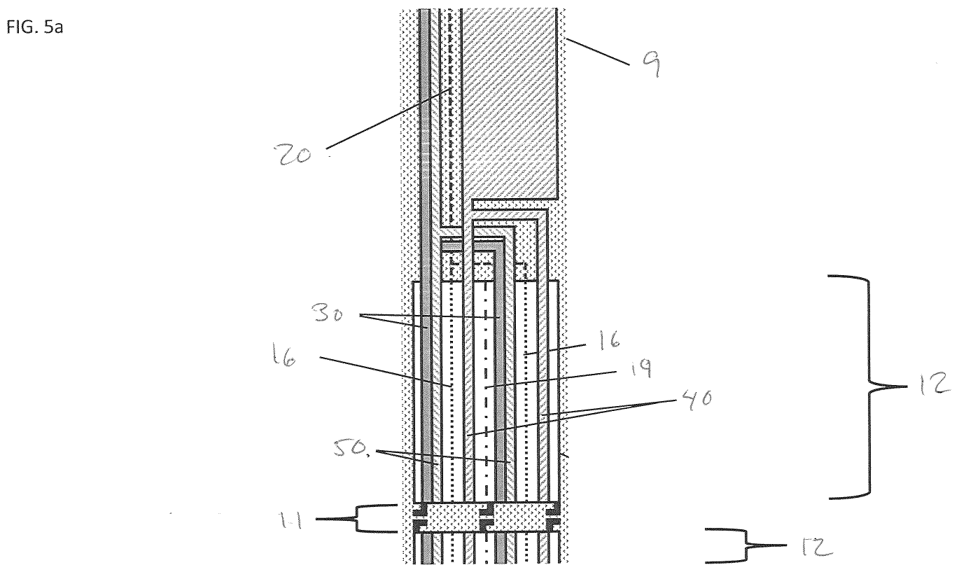

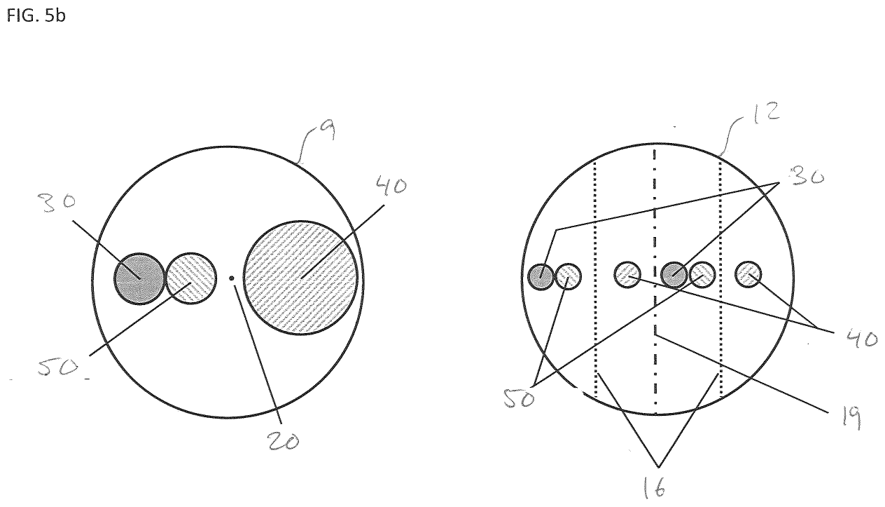

More details of the electrolyzer and placement in vertical or horizontal cased and open-hole wells is displayed in FIG. 2 to 9. FIG. 10 displays details of the single cell electrolyzer device. These single cells can be stacked together to create an electrolyzer stack indicated by the electrolyzer connections in the figures. The electrolyzer configurations involve and are not limited to compartmental and cylindrical geometries that are compatible for vertical or horizontal well or both configurations. The electrolyzer stacks are interlocking to one another allowing for simple build throughout the desired length of well section. The respective tubing strings connect to adjacent electrolyzer stacks thereby permitting conveyance of fluids from one electrolyzer to the other.

In particular, as illustrated in FIG. 2, the tubing strings may be sized to may occupy nearly the entire well cross-section. The cased well is a well that is bounded by a solid casing material 5 to maintain the diameter of the well. In most cases, the solid casing material 5 is made from steel or other common piping material as are commonly known. The combined existing casing S and surrounding underground material provide the ability to store very high-pressure gases safely within the tubing strings. In another embodiment, the casing itself could be used to store the high pressure gases such as, by way of non-limiting example within the annulus between the tubing and the casing.

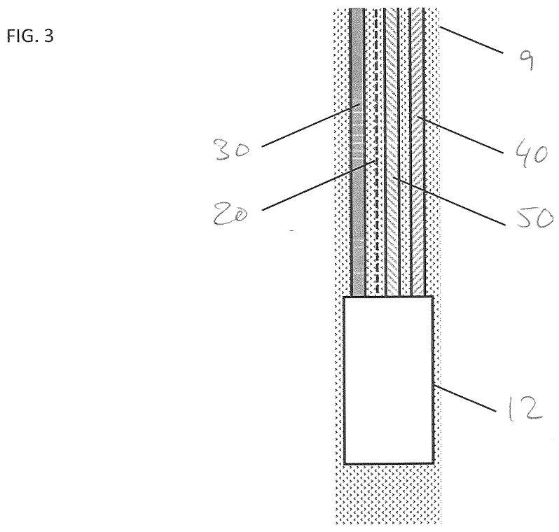

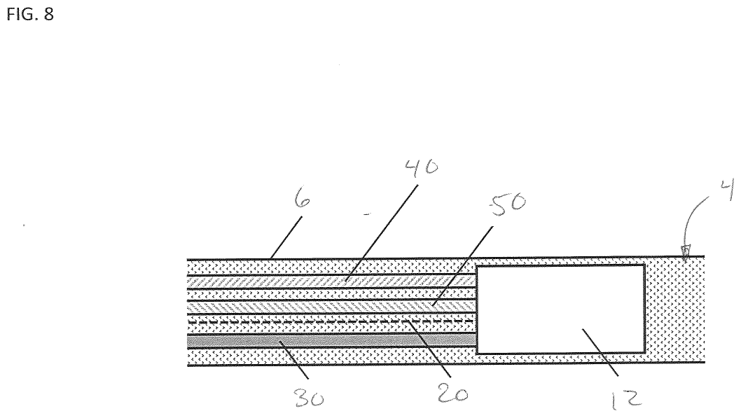

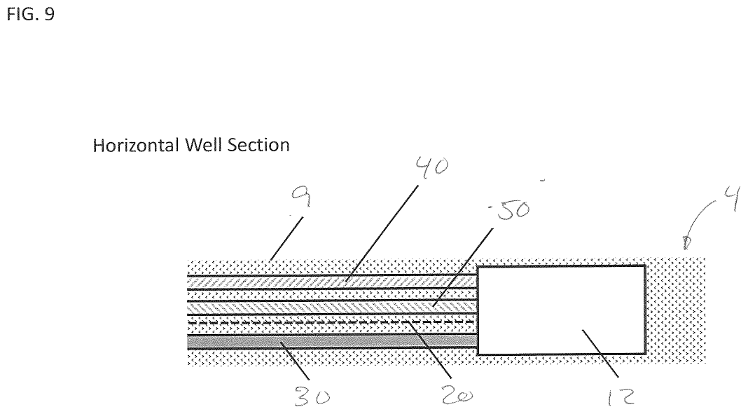

Furthermore, as illustrated in FIG. 3, the system may be located within an open hole well whereby walls of the open hole provide much of the structural strength to store the high-pressure gases within the tubing strings. In another embodiment, the open hole itself could be used to store the high pressure gases. Although FIGS. 2-7b are illustrated in use with a vertical well, it will also be appreciated that the present system may be utilized in a horizontal well or a well with a different orientation as illustrated in FIGS. 8 and 9.

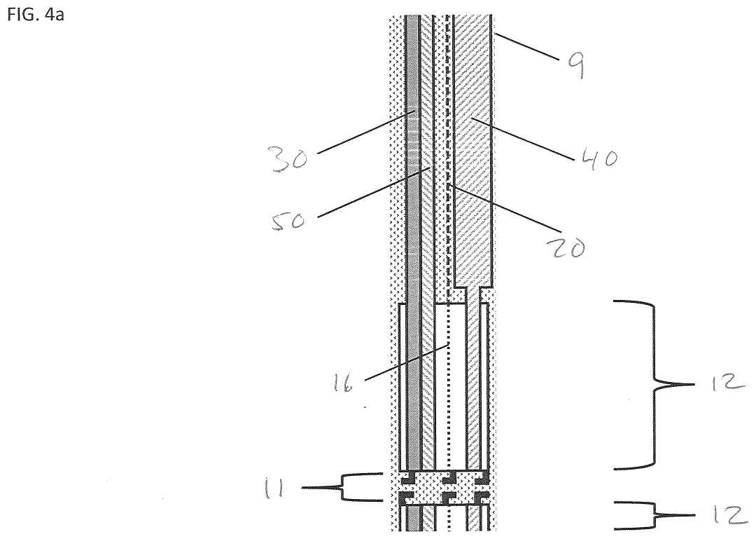

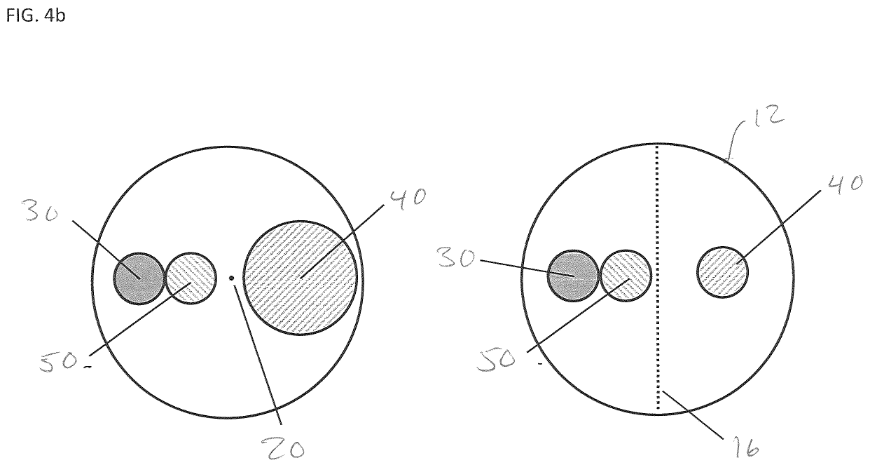

Optionally, as illustrated in FIGS. 4a and 4b, the system may utilize a series of electrolyzers 12. In such embodiments, each of the electrolyzers is connected to each other with a connector 11 to enable passage of water to each electrolyzer and passage of hydrogen and oxygen gases to the surface. As illustrated, the hydrogen line in FIG. 4a may be larger than the oxygen string so as to provide for increased storage of the produced hydrogen.

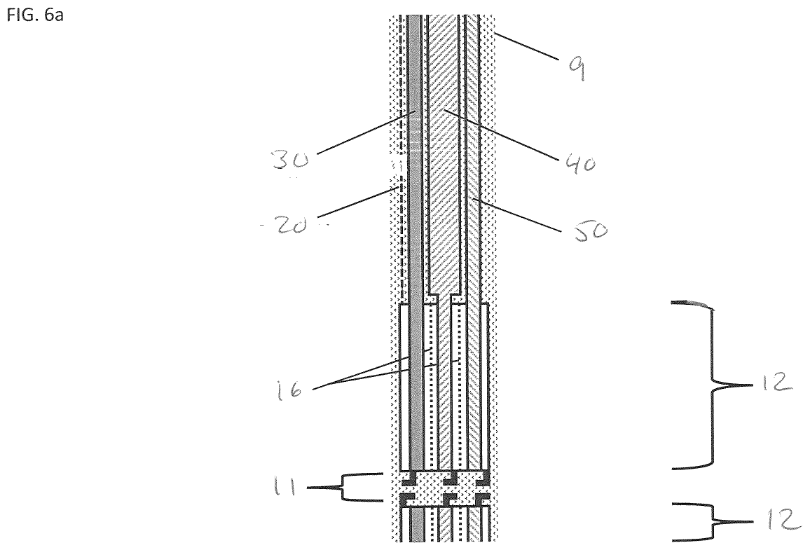

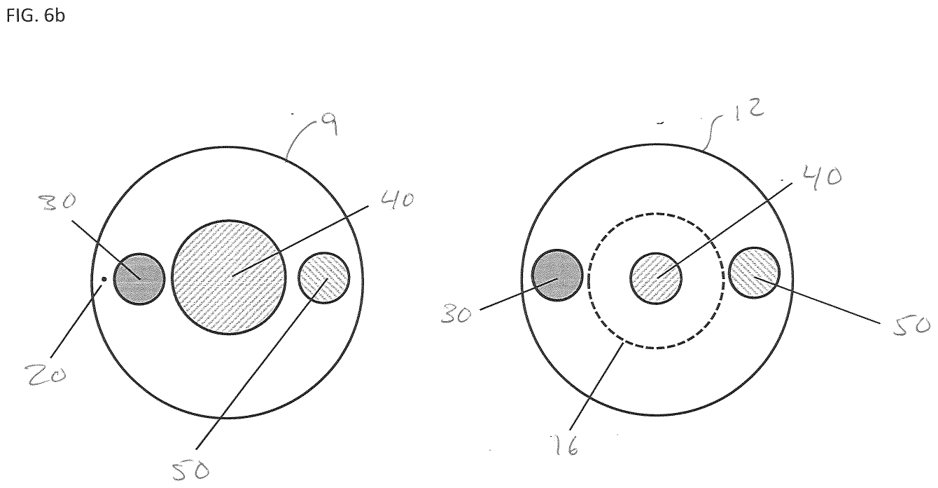

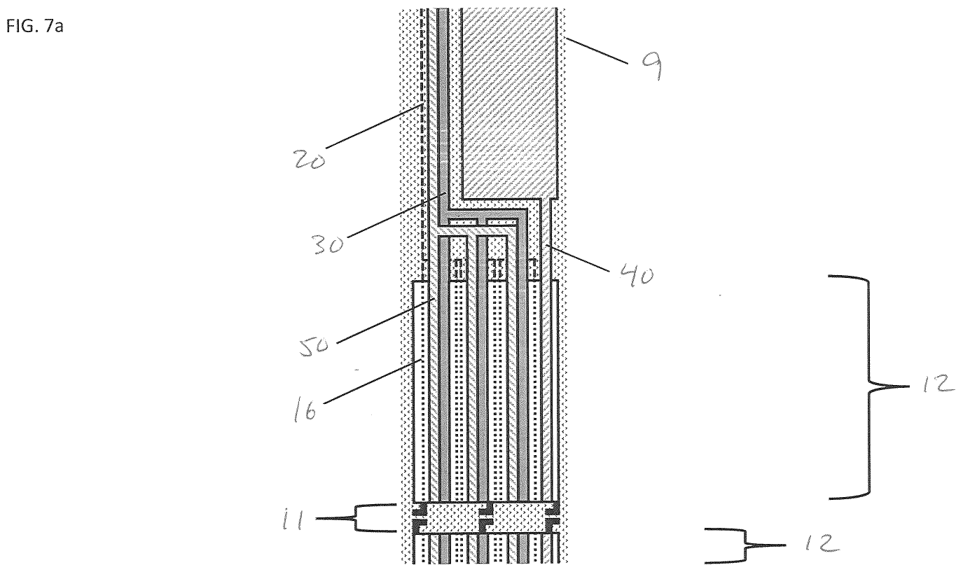

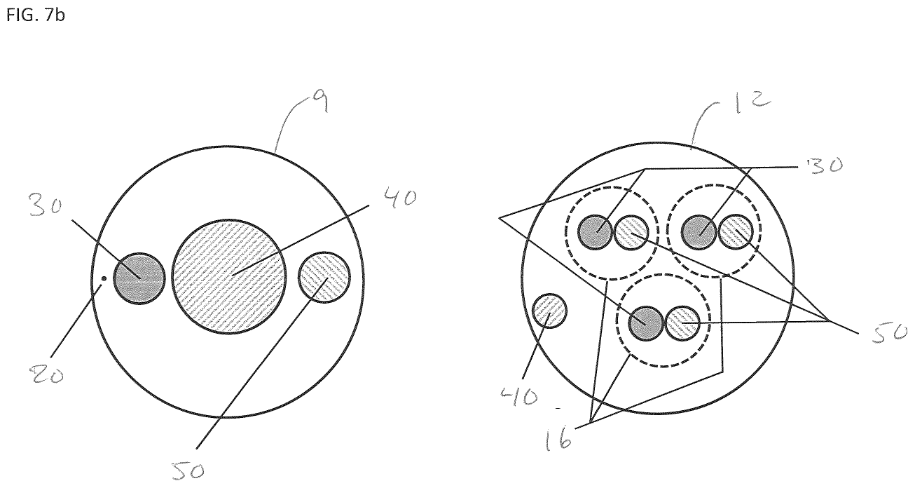

Furthermore, as illustrated in FIG. 6a, a series of double chamber electrolyzers may be utilized such that each of the electrolyzers is connected to each other in series and in parallel with a cell separator 19 therebetween to enable passage of water to each electrolyzer and passage of hydrogen and oxygen gases to the surface. The electrolyzers may be connected to each other and any associated piping with any suitable connector type. Furthermore, each of the electrolyzers may be connected to each other to enable passage of water to each electrolyzer and passage of hydrogen and oxygen gases to the surface as illustrated in FIG. 6a. The water, hydrogen, and oxygen tubing strings can be concentric with respect to each other where two strings sit within the other string or each string sits within an outer string or fed to a collection chamber as illustrated in FIG. 7.

If the target underground zone where the electrolyzer is to be located has water with low salinity or low total dissolved solids, then the method and device can be used with this water. The solubility of hydrogen in the water may be very low and thus, the water blanket surround the hydrogen tubing string acts as a seal to prevent the loss of hydrogen.

The present method can also be used in oil and gas reservoirs or geothermal reservoirs or any underground formation where a well or open-hole exists or can be supported. Old wells that are past their original intended use, e.g. abandoned oil or gas wells, could be used for the method taught here. By way of non-limiting example, the present system may be utilized in existing abandon wells, including, pos-stream oil sand reservoir, steam-assisted gravity drainage (SAGD) wells and the like p where it will be appreciated that remaining heat from the previous SAGD processes will enhance the operation of the electrolyzer.

Methods and system according to the present invention could be used in dry rock or high water content porous rock or underground water zones.

### EXAMPLE

The foundation of this model employs the first law of thermodynamics to predict the operational costs. This law assumes all energy is conserved within a system. Typically, an electrochemical reaction process for hydrogen production utilizes electricity to dissociate liquid water into hydrogen and oxygen gas at standard temperature and pressure. However, heat can be applied to this system as a form of energy to reduce the consumed electricity. The idea of applying heat to an electrochemical system for hydrogen production has been researched since 1980, however the notion of high temperature electrolysis has grown in attention due to the growing hydrogen market forecast and recent breakthroughs in electrochemical materials.

Underground wells offer a source of geothermal heat to achieve an economic edge on hydrogen production competition. In many geothermal systems in Alberta, the temperature ranges 50 deg. C. to 200 deg. C. however it may vary in other locations, such as for example, Iceland where high temperatures wells of 500 deg. C. may be possible.

Applying laws of electrochemistry, the ambient temperature with respect to the electrochemical cell can predict the amount of electricity consumed for a given rate of production in conjunction with recent publications and industry specifications of electrolysis cell performances.

The rate of hydrogen production is mainly affected by material selection, cell geometry, ambient temperature, and electricity consumption. The material selection, cell geometry and heat input dictate the theoretical lowest electricity power requirement for the water dissociation reaction to be possible—a combination of purposely selected electrodes and membrane materials that are exposed to increased temperatures. This means for any supplied electrical power that is greater than the minimum power requirement, the reaction will take place. The minimum theoretical power requirement is indicted by the cell potential. The cell geometry will introduce how much product can be produced for a given rate of production based on the surface area of the electrodes.

Furthermore, these characteristics (i.e. materials, geometry, temperature and electricity supply) are expected to have an impact of the kinetics of the reaction which is difficult to predict mathematically. These losses are due to ohmic resistances, ion migration and ion diffusion. Optimizing these characteristics are expected to have beneficial impacts thereby reducing the cell potential.

Table 1 compares four example scenarios of operation. These examples all employ an electricity cost of $0.03 or $0.04 per kWh and current density of 2 A/cm2. The current density was selected based on typical current densities for hydrogen electrolysis cells, ranging between 1-3 A/cm2. The difference between these three scenarios is the ambient temperature and overpotential.

TABLE 1
Example scenarios (costs in US$).

| | | | | | | | | Hydrogen |
|---|---|---|---|---|---|---|---|---|
| | | | | | | | | and |
| | | | | | | | | oxygen |
| | | | Cell | Over- | Cost of | Current | Cost of | generation |
| | Depth, | Downhole | Potential, | potential, | Electricity, | Density, | Production, | pressure, |
| | km | Temp., ° C. | V | V | $/kWh | A/cm2 | $/kg | atm |
| First | 3.0 | 75 | 1.19 | 0.96* | 0.03 | 2 | 1.73 | 291.5 |
| Scenario | | | | | | | | |
| Second | 3.6 | 90 | 1.17 | 0.40** | 0.03 | 2 | 1.27 | 349.5 |
| Scenario | | | | | | | | |
| Third | 1.5 | 200 | 1.08 | 0.96* | 0.03 | 2 | 1.64 | 146.2 |
| Scenario | (e.g. in | | | | | | | |
| | Iceland) | | | | | | | |
| Fourth | 4.0 | 500 | 0.83 | 0.40** | 0.04 | 2 | 1.32 | 387.3 |
| Scenario | (e.g. in | | | | | | | |
| | Iceland) | | | | | | | |

In any of the examples listed in Table 1, if the water is pressurized at surface, the water at the electrolyzer will have higher pressure than the hydrostatic pressure which would then be the pressure at which the hydrogen and oxygen gases are generated. Thus, even shallow systems could generate high pressure hydrogen and oxygen gases.

The above examples illustrate exemplary methods of conducting in-well electrolysis to produce hydrogen and oxygen to the surface under high pressure conditions. An advantage of the method and apparatus described here is that it takes advantage of geothermal heat to raise the efficiency of electrolysis and that the hydrogen is produced at pressurized conditions.

The hydrogen generated from the methods taught here can be used in fuel 60 cells at surface to generate power, or combusted to produce steam which can be used to generate power or for other in situ oil recovery processes, or sold as industrial chemical feedstock.

The produced hydrogen may be passed through a fuel cell to generate power and the produced water is injected into the well to supply the electrolyzer. The produced hydrogen may be combusted to generate power or heat or steam and/or the produced water or condensed steam is injected into the well to supply the electrolyzer. The produced hydrogen may be used as a chemical feedstock for producing other chemicals.

The electrical power may be used by the electrolyzer is supplied from a solar photovoltaic cell, wind, hydro, nuclear, or fuel generator. The produced oxygen or hydrogen or both may be passed through a turbine-generators 70 to create rotational energy or electrical power. The apparatus may be used to generate hydrogen when intermittent electrical power is available and the stored hydrogen is used for when the power is not available. The apparatus and method may be used in a post-steam or post-thermal recovery process oil reservoir which is thermally stimulated to elevated temperature.

As will be clear from the above, those skilled in the art would be readily able to determine obvious variants capable of providing the described functionality, and all such variants and functional equivalents are intended to fall within the scope of the present invention.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”.
“connected”, “interconnected”, “coupled”, or any variant thereof, means any connection or coupling, either direct or indirect, between two or more elements; the coupling or connection between the elements can be physical, logical, or a combination thereof.
“herein” “above”, “below”, and words of similar import, when used to describe this specification shall refer to this specification as a whole and not to any particular portions of this specification.
“or”, in reference to a list of two or more items, covers all of the following interpretations of the word: any of the items in the list, all of the items in the list, and any combination of the items in the list.
the singular forms “a”, “an” and “the” also include the meaning of any appropriate plural forms.

Unless the context clearly requires otherwise, throughout the description and the claims: Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below” “above” “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Specific examples of methods and systems have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While specific embodiments have been described and illustrated, such embodiments should be considered illustrative only and not as limiting the disclosure as construed in accordance with the accompanying claims.

What is claimed is:

1. A system for producing hydrogen comprising:
at least one electrolyzer adapted to be located within a subterranean formation;
at least one electrical supply cable having a length selected to extend from the at least one electrolyzer to a ground surface power supply;
at least one supply tubing string having a length selected to extend from the at least one electrolyzer to a water supply at the ground surface; and
at least one collection tubing string having a length selected to extend from the at least one electrolyzer to a collection location at the ground surface

2. The system of claim 1 wherein the electrolyzer includes at least one cathode formed of material selected from the group consisting of ruthenium, rhodium, palladium, silver, osmium, iridium, platinum and gold on a substrate formed of a material selected from the group consisting of carbon, titanium dioxide, graphene and alumina.

3. The system of claim 1 wherein the electrolyzer includes at least one anode formed of a material selected from the group consisting of iridium oxide and ruthenium oxide blacks and perfluoroalkylsulfonic acid

4. The system of claim 1 wherein the electrolyzer includes at least one proton exchange membrane to enable separated generation points of oxygen and hydrogen in the electrolyzer.

5. The system of claim 1 wherein the electrolyzer, water, hydrogen and oxygen tubing strings are surrounded by water.

6. The system of claim 1 wherein the at least one electrolyzer comprise at least one the electrolytic cell separated into a first compartment with an electrode for reducing water to hydrogen and second compartment separate from the first compartment with an electrode for generating oxygen.

7. The system of claim 6 wherein a plurality of electrolytic cells are connected together in series or in parallel within the well.

8. The system of claim 1 further comprising a pressure regulator adapted to control the pressure of at least one of produced hydrogen or oxygen within one of the hydrogen tubing string or the oxygen.

9. A method for producing hydrogen comprising:
providing a well from a surface to an underground formation;
locating at least one electrolyzer in the well;
supplying the at least one electrolyzer with supply electricity;
supplying the at least one electrolyzer with supply water;
producing hydrogen gas at the electrolyzer; and
collecting and transporting the produced hydrogen gas to the surface.

10. The method of claim 9 wherein the supply electricity is transported to the at least one electrolyzer from the surface through an electrical power supply cable extending therebetween.

11. The method of claim 9 wherein the supply water is transported from the surface to the at least one electrolyzer through a supply tubing string extending therebetween.

12. The method of claim 11 wherein the supply water is introduced into the supply tubing string at an elevated pressure.

13. The method of claim 11 wherein the supply water is introduced into the supply tubing string at an elevated temperature.

14. The method of claim 9 further comprising transporting the produce hydrogen within at least one collection tubing string extending from the at least one electrolyzer to the surface.

15. The method of claim 14 further comprising controlling the surface production of hydrogen or oxygen or both from their respective tubing strings to maintain a desired pressure of the gases in their respective tubing strings.

16. The method of claim 9 further comprising and utilizing the underground well as structural support for produced hydrogen storage before transportation to the surface.

17. The method of claim 9 wherein a pressure of the generated hydrogen and oxygen gases in their respective tubing strings may be accumulated until a desired pressure is reached up to and not exceeding the maximum underground storage pressure of the tubing strings.

18. The method of claim 9 further comprising determining the highest temperature location within the well and locating the at least one electrolyzer at the highest temperature location.

19. The method of claim 9 further comprising locating the at least one electrolyzer at the deepest section of the well.

20. The method of claim 9 wherein the well is selected to be a post-steam or post-thermal recovery process oil reservoir.

21. The method of claim 9 wherein the produced hydrogen is passed through a fuel cell to generate power.

22. The method of claim 9 wherein the produced water is injected into the well to supply the electrolyzer.

23. The method of claim 9 wherein the produced hydrogen is combusted to generate at least one of power, heat and steam.

24. The method of claim 9 wherein the produced water or condensed steam is injected into the well to supply the electrolyzer.

25. The method of claim 9 wherein the electrical power used by the electrolyzer is supplied from at least one of a solar photovoltaic cell, wind, hydro, nuclear and fuel generator.

26. The method of claim 9 wherein at least one of the produced oxygen and hydrogen is passed through a turbine-generator to create at least one of rotational energy and electrical power.

27. The method of claim 9 wherein the hydrogen is reduced from water in a first compartment with an electrode for reducing water to hydrogen oxygen is reduced from water in a second compartment which is located separate from the first compartment with an electrode connected electrically to the electrode of the first compartment.

28. The method of claim 9 wherein the water in the electrolyzer is at the hydrostatic pressure at the submersion depth of the electrolyzer.

29. The method of claim 9 wherein the generated oxygen and hydrogen is at the pressure of the electrolyzer and is delivered into their respective production tubing strings that are connected to the electrolyzer and surface.

30. A method for producing hydrogen from a underground system comprising:
providing a well from surface to the underground;
locating at least one electrolyzer in the well at one or more depths;
supplying water to the electrolyzer through a connection;
supplying electrical current to the electrolyzer to generate oxygen and hydrogen;
separating the generated oxygen and hydrogen to fill at least one hydrogen tubing string and at least one oxygen tubing string to a desired pressure;
producing the gases from the tubing strings separately at the desired target pressure on surface;
generating energy through at least one of:
passing at least one of the high pressure oxygen and hydrogen through a turbine to generate rotational energy;
passing at least one of the high pressure oxygen or hydrogen a turbine and electrical generator to generate electrical power;
feeding the produced hydrogen to a combustion engine and combusting it for rotational energy;
feeding the hydrogen to combustor for heat; and
feeding the hydrogen to a fuel cell for the generation of electrical power;
providing the produced water from the step of generating energy to feed the electrolyzer;
passing the high pressure oxygen at a desired pressure to a storage vessel on the surface for storage or transport; and
passing the high pressure hydrogen at a desired pressure to a storage vessel on the surface for storage or transport.
